(19) United States
(12) Patent Application Publication
(10) Pub. No.: US 2023/0329196 A1
(43) Pub. Date: Oct. 19, 2023

(54) DISTRIBUTION-BASED MACHINE LEARNING

(71) Applicant: X Development LLC, Mountain View, CA (US)

(72) Inventors: Pedro Montebello Milani, Redwood City, CA (US); Jung Ook Hong, Sunnyvale, CA (US); Rajesh Machhindranath Jadhav, San Ramon, CA (US); Yangli Hector Yee, San Francisco, CA (US); Cory Drew Schillaci, Berkeley, CA (US); Julia Black Ling, Menlo Park, CA (US)

(21) Appl. No.: 18/133,955

(22) Filed: Apr. 12, 2023

Related U.S. Application Data
(60) Provisional application No. 63/330,513, filed on Apr. 13, 2022.
(60) Provisional application No. 63/431,280, filed on Dec. 8, 2022.

(51) Int. Cl. A01K 61/95; A01K 63/00

(52) U.S. Cl. CPC A01K 61/95; A01K 63/003

(57) ABSTRACT

Methods, systems, and apparatus, including computer programs encoded on computer-storage media, for distribution-based machine learning. In some implementations, a method for distribution-based machine learning includes obtaining fish images from a camera device; generating predicted values using a machine learning model and one or more of the fish images; comparing the predicted values to distribution data representing features of multiple fish; and updating one or more parameters of the machine learning model based on the comparison.

### CROSS-REFERENCE TO RELATED APPLICATION

This application claims the benefit of U.S. Provisional Application No. 63/330,513, filed Apr. 13, 2022 and U.S. Provisional Application No. 63/431,280, filed Dec. 8, 2022, the contents of which are incorporated by reference herein.

### FIELD

This specification generally relates to improved machine learning methods in aquaculture, agriculture, or other scenarios.

### BACKGROUND

End-to-end training of machine learning models to predict biomass of fish typically require ground truth data indicating known weights of specific fish corresponding to specific images of the fish. Obtaining such data can be time consuming and damaging to fish. Moreover, data obtained in controlled environments, where ground truths are typically obtained, may not be representative of environments where a trained model is then used. For example, images obtained in an enclosed, controlled, chamber used for ground truth data collection may have less particulates or imperfections compared to images obtained from a fish pen used in aquaculture. This difference can contribute to increased model prediction error.

### SUMMARY

To solve the issue of images in training data not being representative of actual environments, one may use images from those actual environments, e.g., fish pens in aquaculture, for training data. However, this can present additional challenges in obtaining corresponding ground truth data. To obtain ground truth data using traditional training methods would require isolating the imaged fish to determine their actual weight, which in turn can potentially damage the fish and, in general, be time consuming and manual labor intensive.

A solution described in this specification includes techniques to enable the use of images from actual environments in training data by using fish population data as ground truth data instead of individual fish measurements. The solution described herein can generate a trained model that is configured to predict weight of individual fish without being trained using training data that uses weight of individual fish. This is made possible, in part, by defining a model that predicts weight of individual fish from corresponding observed markers in the three dimensional (3D) space, but training the model with respect to a loss function that optimizes deviations with respect to parameters representing a distribution of the training data. This allows for using training data from actual environments—thereby potentially increasing accuracy of prediction— without having to weigh individual fish from the population being used to generate the training data (which in turn can reduce potential harm to fish as well as the time/labor required for the process).

Fish population data can include one or more values that represent a distribution of a fish population, such as a population that has been sorted, harvested, or otherwise processed. Because population based metrics are already obtained for other purposes, their use can improve training data generation efficiency. Also, the ability to use images from actual environments in training data can significantly improve performance of prediction machine learning models compared to models trained using training data obtained in a controlled, non-production, environment.

In some implementations, fish are weighed collectively, e.g., during harvesting. A number of fish in different weight or size ranges can be determined during harvesting. Metrics indicating a population that has been measured in this way can be used as a form of ground truth data for training a model. A model being trained can use production images, e.g., images obtained from a fish pen, of a population of fish that has been, or will be, measured. A system can provide the input data and compare one or more predicted values with the known population values to determine one or more adjustments to the model to optimize predictions, such as predictions of biomass.

In some implementations, a model being trained generates a predicted weight for multiple fish. For example, a model can generate a predicted weight using input data such as an image of a fish or extracted data, such as key points on a detected fish or truss lengths between key points. A training system can compare multiple predicted weights generated by the model to one or more values representing a population of measured fish.

In some implementations, a training system generates a loss from a loss function, e.g., a scalar function, to determine adjustments to a machine learning model being trained. A loss function can be continuously differentiable with respect to inputs to enable a training system to perform gradient descent optimization. In some implementations, a training system adjusts a model being trained based on output of a loss function. For example, a training system can provide multiple predicted fish weights and one or more values representing a population of measured fish to a loss function. The training system can obtain a loss value from the loss function, e.g., a gradient of the loss function with respect to changing input values, and adjust a model being trained based on the loss value, including adjusting one or more weights or parameters of the model.

One innovative aspect of the subject matter described in this specification is embodied in a method that includes obtaining fish images from a camera device; generating predicted values using a machine learning model and one or more of the fish images; comparing the predicted values to distribution data representing features of multiple fish; and updating one or more parameters of the machine learning model based on the comparison.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the camera device is equipped with locomotion devices for moving within a fish pen. In some implementations, the predicted values include one or more values indicating a weight of a fish represented by the fish images. In some implementations, the fish images include two images from a pair of stereo cameras of the camera device. In some implementations, actions include obtaining the distribution data representing the features of the multiple fish from a system that measures the multiple fish.

In some implementations, actions include measuring the multiple fish to generate the distribution data representing the features of the multiple fish. In some implementations, the features of the multiple fish include a total weight of the multiple fish. In some implementations, actions include generating the distribution data representing the features of the multiple fish. In some implementations, generating the distribution data representing the features of the multiple fish includes obtaining data representing fish satisfying a feature criteria; and generating the distribution data as a combination of the data representing fish satisfying the feature criteria and data representing fish not satisfying the feature criteria.

In some implementations, the feature criteria includes a weight threshold. In some implementations, comparing the predicted values to the distribution data representing the features of the multiple fish includes comparing one or more values representing one or more predicted weights of fish represented in the fish images to one or more values representing one or more known weights of fish not represented in the fish images. In some implementations, generating the predicted values includes generating a predicted distribution; and generating a transformed version of the predicted distribution as the predicted values.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for distribution-based machine learning.

FIG. 2 is a flow diagram illustrating an example of a process for distribution-based machine learning.

FIG. 3 is a diagram illustrating an example of a computing system used for distribution-based machine learning.

FIG. 4A is a diagram showing comparison results from evaluation tests of a model trained using distribution-based machine learning.

FIG. 4B is a diagram showing comparison results from evaluation tests of a model trained using distribution-based machine learning.

FIG. 5 is a diagram showing a comparison between an original distribution, a corrected distribution, and a ground truth distribution.

Like reference numbers and designations in the various drawings indicate like elements.

### DETAILED DESCRIPTION

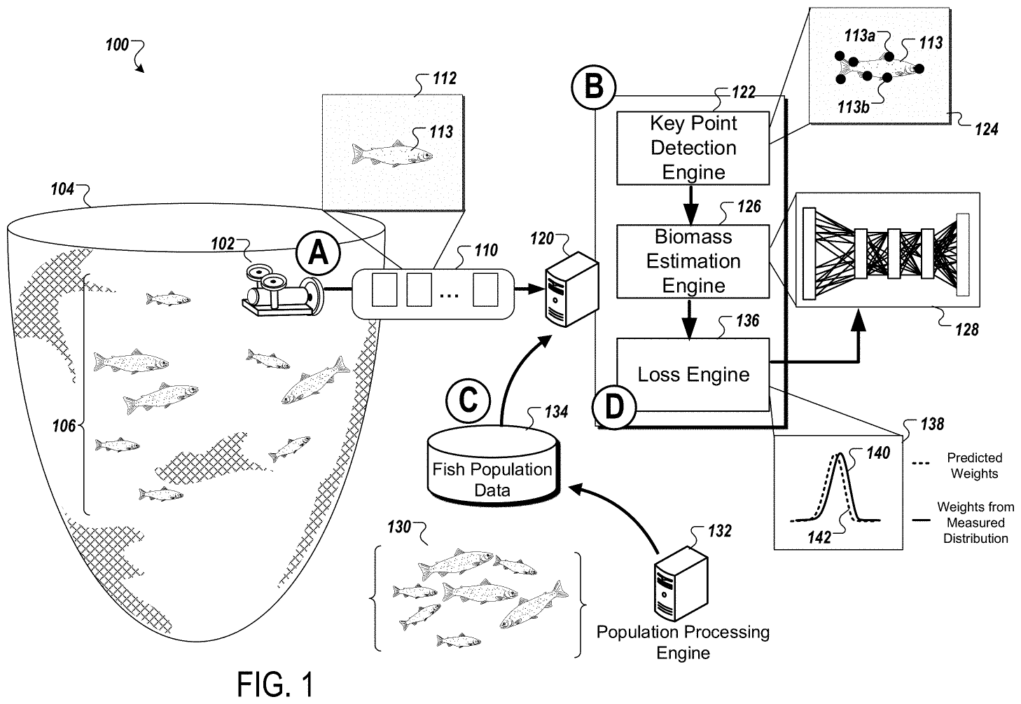

FIG. 1 is a diagram showing an example of a system 100 for distribution-based machine learning. The system 100 includes a camera device 102, control unit 120, and a population processing engine 132. In some implementations, the control unit 120 performs operations of the population processing engine 132.

In general, the control unit 120 trains a machine learning model 128 using processed metrics of a fish population 130 as ground truth data. The control unit 120 can train the model 128 to predict a biomass or other feature of an imaged fish. The control unit 120 obtains images from the device 102 and provides data based on the obtained images to the model 128. Output of the model 128 can indicate a given feature for an imaged fish, such as biomass or weight of the imaged fish.

In stage A, the control unit 120 obtains data 110 from the camera device 102. The camera device 102 can be configured with motors or attachments for winches to be able to move around fish pen 104 and image the fish 106 inside the fish pen 104. The data 110 includes images of fish, such as the image 112 of the fish 113.

In stage B, the control unit 120 provides data to a key point detection engine 122. The data can include the image 112 or data representing the image 112. The key point detection engine 122 detects one or more key points, e.g., points 113a and 113b, on the fish 113 representing specific locations or portions of the fish 113. Location can include locations of body parts such as fins, eyes, gills, nose, among others.

The key point detection engine 122 provides data to a biomass estimation engine 126. The biomass estimation engine 126 generates a biomass estimation and provides the biomass estimation to a loss engine 136. The biomass estimation engine 126 operates the model 128. The model 128 can be partially trained, not trained, or fully trained. The model 128 can include one or more layers with values connecting the one or more layers to generate output from input based on successive operations performed by each layer of the model 128.

In some implementations, the biomass estimation engine 126 includes stereo matching and triangulation processing. For example, the camera device can include one or more cameras, such as one or more stereo camera pairs, to capture images from multiple perspectives. The biomass estimation engine 126 can use key points identified by the key point detection engine 122 in both images from a stereo image pair and match the two dimensional key points, e.g., in image coordinates, from the cameras and generate an approximate three dimensional location of those points. The data 110 can include depth perception to help the stereo matching and triangulation processing.

In some implementations, the key point detection engine 122 determines three dimensional key points using one or more images. For example, the key point detection engine 122 can combine stereo image pairs to determine a location of key points in three dimensions. In some implementations, the key point detection engine 122 generates three dimensional key points using non stereo image pairs. For example, the key point detection engine 122 can provide one or more images to a machine learning model trained to estimate three dimensional key points based on obtained images. The key point detection engine 122 can provide generated 3D key points to the biomass estimation engine 126.

In some implementations, the data provided to the biomass estimation engine 126 includes three dimensional key points. In some implementations, the biomass estimation engine 126 generates three dimensional key points using two-dimensional key points generated by the key point detection engine 122. In some implementations, the biomass estimation engine 126 directly obtains images and provides the images to the model 128. The model 128 can be trained to generate biomass predictions using obtained images of fish.

In some implementations, the biomass estimation engine 126 generates truss lengths for inputting to the model 128. For example, the biomass estimation engine 126 can obtain two or three dimensional key points detected using the key point detection engine 122 and determine one or more distances between the key points as one or more truss lengths. In some implementations, the biomass estimation engine 126 provides the one or more truss lengths to the model 128 as input. The model 128 can be trained to accept a number of different types of input for generating biomass, or other feature, predictions.

The biomass estimation engine 126 provides a prediction generated by the model 128 to the loss engine 136. The prediction can include a prediction of any feature that the model 128 is trained to predict, such as biomass, deformities, size, health, among others. In general, instances of weight prediction can be replaced with other features such that the techniques described herein can be used for distribution based predictions of those features.

In stage C, the control unit 120 obtains population data from fish population data 134. The fish population data 134 is generated by the population processing engine 132. The population processing engine 132 measures features of the population of fish 130. The features can include a weight of the population of fish 130, such as a total weight when all the fish 130 are on a scale for measuring weight. The features can include a total indication of health for the group, a total indication of sizes, among other features.

The control unit 120 provides the population data to the loss engine 136. In stage D, the loss engine 136 determines a loss value and adjusts the model 128 using the loss value. In some implementations, the loss value is determined by comparing a distribution of one or more predictions generated by the model 128 and the population data obtained from the fish population data 134. For example, as shown in item 138, the loss engine 136 can determine a difference between a distribution 140 representing the population data obtained from the fish population data 134 and a distribution 142 representing a combination of two or more predictions, such as predicted weights, generated by the model 128.

In some implementations, the loss engine 136 adjusts one or more weights or parameters of the model 128 using output from a loss function operated by the loss engine 136. For example, the loss engine 136 can generate output from a loss function. The loss engine 136 can generate loss function output for given predictions of the model 128 and measured ground truth data for the fish population 130. The loss engine 136 can generate a gradient value with respect to parameters of the model 128 and apply one or more iterations of a gradient descent algorithm using the generated gradient value to optimize parameters of the model 128.

In some implementations, data from the fish population data 134 is obtained by the control unit 120 and split into training data and evaluation data. The model 128 can be trained, e.g., by the control unit 120, using a training data portion of the fish population data 134. Then, the control unit 120 can evaluate the model 128 using an evaluation data portion of the fish population data 134. The control unit 120 can determine if performance of the model 128 satisfies one or more thresholds, e.g., if the output of the model agrees with known values of fish represented by the evaluation data portion of the fish population data 134.

In some implementations, parameters of the model 128 are randomly initialized. In some implementations, the model 128 is adjusted using the loss engine 136 and one or more gradient descent optimization techniques. Of course, other optimization techniques may also be used either instead of, or in addition to, gradient descent optimization.

In some implementations, the loss engine 136 applies one or more steps of gradient descent using one or more generated loss values. For example, the loss engine 136 can generate a first loss value between the ground truth distribution 140 and the predicted distribution 142. The loss engine 136 can apply one step of gradient descent, or other optimization algorithm, to optimize one or more weights of parameters of the model 128.

In some implementations, the loss engine 136 generates a loss from a loss function. An example loss function can be, (mean(Y)−mean(g))\hat{ }2+(std(Y)−std(g))\hat{ }2+sum(percentiles(Y)−percentiles(g))\hat{ }2, where Y represents a series of predictions, e.g., for one or more different fish, generated by the model 128, e.g., y1, y2, . . . , yN, g represents a ground truth distribution generated from the population data of the fish population data 134, e.g., a mean, standard deviation, or percentiles. N can represent a number of fish, e.g., used in a batch for gradient descent. N can be chosen at random from all available observations. Of course other expressions, or values representing a processed distribution of fish can be used to determine a difference between the predictions of the model 128 and ground truth data collected for the fish population 130.

In some implementations, a loss function operated by the loss engine 136 is differentiable. For example, the loss function can be continuously differentiable. In some implementations, moments of the distribution (e.g., a mean, standard deviation, skewness, Kurtosis, among others) are included as components in the loss function. In some implementations, including percentiles are important as they allow comparison of a distribution in a differentiable way. For example, moments of the distribution can be compared but may not fully represent the distribution in a comparison, e.g., to another known distribution. Other possible components, such as Kullback-Leibler (KL) divergence may not be differentiable in this context.

In some implementations, a loss function operated by the loss engine 136 includes one or more tunable weights. For example, a1*((mean(Y)−mean(g))\hat{ }2+a2*(std(Y)−std(g))\hat{ }2+a3*sum(percentiles(Y)−percentiles(g))\hat{ }2, where a1, a2, and a3 can include any number, e.g., positive rational numbers. In some implementations, weights can be tuned during one or more training operations or manually by a user of the system. In some implementations, a loss function includes other values, or can be varied automatically or by a user of the system. For example, a loss function can include L1 or L2 norms, mean or sum of percentiles, among others.

In some implementations, the fish population 130 is a portion of a population from the fish pen 104. For example, the fish population 130 can be removed from the fish pen 104, e.g., using one or more instructions generated by the control unit 120 to one or more sorting actuators or mechanical processes. The fish population 130 can be processed for bulk measurements, harvested, among others.

In some implementations, the control unit 120 approximates an underlying distribution using measurements representing a portion of a population. For example, the control unit 120 can approximate one or more of a mean, standard deviation, percentiles, among other statistics, for a population based on a portion of the population being measured. The approximated population distribution can be used by the loss engine 136 to determine a loss value for adjusting the model 128.

In some implementations, the model 128 includes one or more input layers for truss lengths, one or more hidden layers, and an output layer indicating a prediction based on input. For example, the model 128 can include an input layer for receiving a specific number of truss lengths to define a fish, e.g., 45 trusses. The model 128 can output a weight, e.g., of a single fish in grams.

In some implementations, the control unit 120 performs one or more operations described as performed by the key point detection engine 122, the biomass estimation engine 126, or the loss engine 136. In some implementations, the control unit 120 provides data to one or more other processing components to perform operations described as performed by the key point detection engine 122, the biomass estimation engine 126, or the loss engine 136.

FIG. 1 is discussed in stages A through D for ease of explanation. Stages may be reordered, removed, replaced. For example, the system 100 can perform operations described with reference to stage C while obtaining the data 110 from the camera device 102. Components of FIG. 1 can provide and obtain data from other components using one or more wired or wireless networks for communicating data, e.g., the Internet. Although discussed in reference to fish, the techniques described herein may be applied to other animals or articles of manufacture.

In some implementations, the control unit 120 directly predicts a distribution. For example, the control unit 120 can train a machine learning model to predict weight estimate distributions using ground truth weight distribution, e.g., obtained from the fish population 130. The ground truth weight distribution can include one or more weights determined during a harvesting of the fish population 130. In some implementations, the control unit 120 generates a mapping between predicted distributions and actual distributions. Such a mapping can be consistent over multiple harvest sessions. Such a mapping can be independent of a season of the harvest.

In some implementations, the control unit 120 generates one or more cumulative distribution functions (CDFs). For example, the control unit 120 can generate a first CDF from a predicted weight distribution and a second CDF from an actual weights distribution. The first CDF can be generated by the control unit 120 by the biomass estimation engine 126 or by another distribution based prediction system. The second CDF can be generated using data from the fish population data 134 representing the fish population 130.

In some implementations, the control unit 120 splits a data set into a training dataset and testing dataset. For example, the control unit 120 can generate a mapping as a transformation function for a distribution generated from a training data set to approximate a ground truth distribution. The transformation function can be applied to a testing data set. A comparison between a truth distribution—e.g., generated from the fish population data 134 representing the fish population 130—and the transformed testing data set can be performed by the loss engine 136 to validate the generated mapping and to inform automatic or manual adjustment of one or more parameters of the transformation function.

In some implementations, the control unit 120 trains a machine learning model trained to predict distributions instead of, or in addition to, training the model 128. For example, the model 128 can be trained to predict individual fish weights instead of distributions but can be used iteratively, e.g., by the control unit 120, to generate one or more distributions by the control unit 120 combining individual weight predictions of the model 128. In some implementations, the control unit 120 uses the model 128 to generate an initial predicted distribution for which to generate a transformation to determine a more accurate distribution based on comparing to a distribution from harvest data. In general, this sort of mapping can help alleviate bias or other issues with a prediction of individual weights or weight distribution for a given population, e.g., of fish or other organism.

In some implementations, the machine learning model trained to predict distributions includes a mapping of predicted weight to ground truth harvest weight. During training of the machine learning model, a distribution generated from, e.g., the fish population 130, can be compared to a prediction of a distribution for the fish population 130. The machine learning model, after training in this way over one or more populations of fish, can be generalizable to correct weight predictions for which a ground truth value is not available—e.g., because the fish have not yet been harvested.

In some implementations, the control unit 120 updates the model 128 based on comparing one or more values representing a predicted weight distribution and one or more values representing a ground truth harvest weight distribution. For example, the control unit 120 can be used to improve a model, e.g., that generates one or more truss lengths per fish, identifies key points, generates a ground truth weight per fish, among others. In some implementations, the model 128 can generate one or more truss lengths when computing one or more harvest weights to generate a predicted weight distribution. In some implementations, the key point detection engine 122 includes one or more models trained to detect key points on a fish. In some implementations, the model 128 predicts weight of fish without being provided key points by a separate model. For example, the biomass estimate engine 126 can use the model 128 to generate weight estimates directly from obtained images, e.g., from the data 110 from the camera device 102.

In some implementations, the control unit 120 generates a truss length distribution. For example, the control unit 120 can generate a truss length distribution using one or more trained models, e.g., the model 128. The truss length distribution can represent truss lengths of a population of fish represented in data obtained from, e.g., the device 102. In some implementations, the control unit 120 generates a weight distribution using a truss length distribution. For example, the control unit 120 can use one or more trained models to map—e.g., using a parametric or non-parametric model—a truss length distribution to a weight distribution. The control unit 120 can use one or more ground truth data sets to compare a predicted truss length distribution or a weight distribution to a known truss length distribution or weight distribution.

In some implementations, the control unit 120 generates a key point distribution. For example, the control unit 120 can generate a key point distribution using one or more trained models, e.g., the model 128. The key point distribution can represent key points of a population of fish represented in data obtained from, e.g., the device 102. In some implementations, the control unit 120 generates a weight distribution using a key point distribution. For example, the control unit 120 can use one or more trained models to map—e.g., using a parametric or non-parametric model—a key point distribution to a weight distribution. The control unit 120 can use one or more ground truth data sets to compare a predicted key point distribution or a weight distribution to a known key point distribution or weight distribution.

In some implementations, the control unit 120 filters one or more images before using the images to generate biomass estimates. For example, the control unit 120 can filter images based on one or more of the following features: time of day, proximity of subject in image to camera—e.g., the camera 102, track length—e.g., how many frames include a given fish or other object, species in an image, camera depth, among others. In some implementations, the control unit 120 uses Bayesian optimization to determine hyperparameters for filtering based on one or more features. For example, using Bayesian optimization, the control unit 120 can adjust one or more hyperparameters that affect the likelihood that a given image will be filtered or not based on what the given image represents.

In some implementations, the control unit 120 determines an elapsed time or amount of observed fish before using the loss engine 136 to compare distributions. For example, the control unit 120 can wait for a 24 hours while images are being obtained and weight estimates are being generated based on the images. After 24 hours, or any other suitable amount of time which could be tunable—e.g., using one or more optimization techniques for hyperparameters, the control unit 120 can use the loss engine 136 to compare the weight estimates, as a distribution, to the distribution generated from the fish population data 134. In another example, the control unit 120 can wait for an amount of fish to be observed before performing comparisons in the loss engine 136. In some implementations, the control unit 120 uses a trained model to determine how many fish weights or how long to obtain images before comparison. For example, the control unit 120 can use Bayesian optimization or other methods to adjust how long, or how many generated weights, are to be generated before using the loss engine 136 to compare a generated set of weights to a ground truth distribution.

In some implementations, a predicted weight distribution, e.g., generated by the biomass estimation engine 126, is compared to a ground truth distribution by comparing one or more distribution parameters that represent the corresponding distributions. For example, the control unit 120 can compare distribution 140 and 142 by comparing parameters that represent the distributions, such as mean, standard deviation, mode, among others.

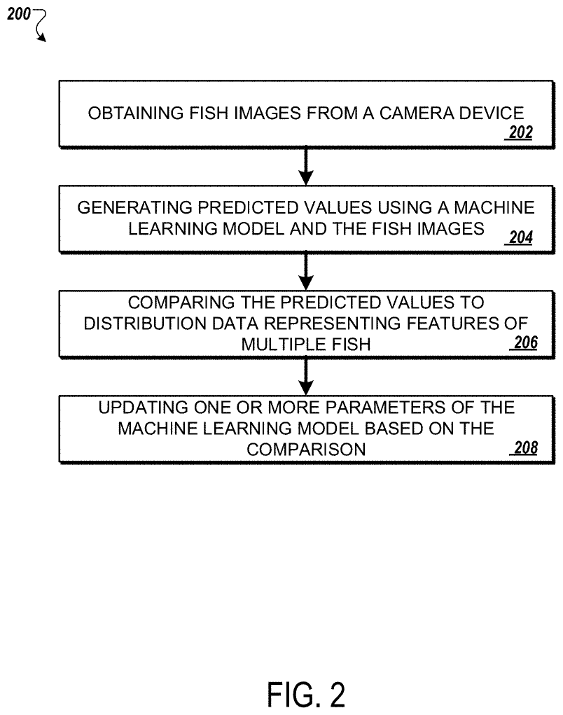

FIG. 2 is a flow diagram illustrating an example of a process 200 for distribution-based machine learning. The process 200 may be performed by one or more electronic systems, for example, the system 100 of FIG. 1.

The process 200 includes obtaining fish images from a camera device (202). For example, the control unit 120 can obtain the data 110 from the camera device 102. The data 110 can include images of fish, such as the image 112 of the fish 113.

The process 200 includes generating predicted values using a machine learning model and the fish images (204). For example, the biomass estimation engine 126 generates a prediction of a feature of one or more imaged fish. Although described as training a model for biomass prediction, in some implementations, the system 100 can train a model to predict other features that can be measured in bulk, e.g., from the population 130, such as health, nutrition value, deformities, ectoparasites, among others.

The process 200 includes comparing the predicted values to distribution data representing features of multiple fish (206). For example, the loss engine 136 can determine a difference between a distribution 140 representing a measured population, e.g., the population 130, and a distribution 142 predicted by the model 128.

The process 200 includes updating one or more parameters of the machine learning model based on the comparison, e.g., between the predicted values and the distribution data representing features of multiple fish (208). For example, the loss engine 136 can adjust one or more parameters of the model 128 to optimize output of the model 128. One or more optimization techniques, such as gradient descent, can be used to adjust one or more parameters of the model 128 based on values of a loss function operated by the loss engine 136.

In some implementations, additional training data is used to supplement distribution based training data. For example, for some sizes or types of fish, distribution-based ground truth data can be used. For other sizes or types of fish, normal ground truth data can be collected and used or can be added to the distribution based training data to augment the distribution based training data. The size or type of fish can be chosen as a size or type of fish that cannot be generalized well to a distribution or is difficult to measure or is lacking corresponding training data, such as data available at harvest.

In some implementations, ground truth distribution data is augmented to include a range of different types of fish. For example, the distribution 140 representing the population data obtained from the fish population data 134 can be generated by the control unit 120 to include data representing fish not included in the population 130. The control unit 120 can obtain additional data representing other fish and include the additional data in a ground truth distribution—e.g., distribution 140—for training the model 128.

In some implementations, the control unit 120 determines that a distribution generated from a population does not represent one or more types of fish. For example, the control unit 120 can determine that a distribution does not represent one or more species, sizes, weights, ages, health condition, or other types of fish. In response to determining the distribution generated from a population does not represent one or more types of fish, the control unit 120 can obtain additional data representing the type of fish not represented. The control unit 120 can generate a new distribution to be used as a ground truth distribution in the loss engine 136 that includes a representation of the additional data representing the type of fish not represented in the original distribution.

In some implementations, the additional data representing the type of fish not represented includes distribution data, e.g., representing one or more fish of the type of fish not represented in an original distribution. For example, the additional data representing the type of fish not represented can represent one or more fish in the range of 1 kilogram (kg) to 3 kg, or other suitable range. The additional data can be obtained from manual observation or a system configured to image, weigh, or otherwise detect features of fish. In general, the model 128 can improve its predictions for certain types of fish with ground truth data augmented to include additional training samples of the certain types of fish.

In some implementations, a model is trained to predict values for smaller fish using traditional ground truth data representing a specific fish and trained to predict values for larger fish using distribution-based ground truth data. For example, the control unit 120 can provide the model 128 with input training data generated with small fish in a controlled environment where images can be taken and measurements made. The control unit 120 can obtain output from the model 128 indicating a predicted value for a specific fish depicted in one or more images obtained in a controlled environment. The control unit 120 can compare the predicted value, such as weight, to a known value measured for the specific fish in the controlled environment.

In some implementations, a model does not perform well for specific types or sizes of fish when trained exclusively on distribution-based data. For example, the model 128, if trained exclusively on distribution-based ground truth data representing larger fish, may not perform well when predicting values for small fish, e.g., fish with a size that satisfies a size threshold. The size threshold can be 2 kg where fish less than or less than or equal to the threshold are identified as small fish. In some implementations, a model does not perform well for specific types or sizes of fish when trained exclusively on distribution-based data because insufficient training data exists for a specific type or size of fish. For example, smaller fish may not be harvested as frequently as larger fish and so the training data may be biased for larger fish leading to inaccuracies when a model trained using corresponding distribution-based training data generates predictions for smaller fish. A solution to this problem is to supplement training data for sizes or types of fish for which a model does not perform well, e.g., below a certain accuracy threshold, in predicting one or more values. For example, small fish ground truth data can be collected and used to train a given mode, such as the model 128, separately from the training using distribution-based data.

Although primarily discussed in reference to fish, the techniques described herein can be used for any other organism as one skilled in the art will appreciate.

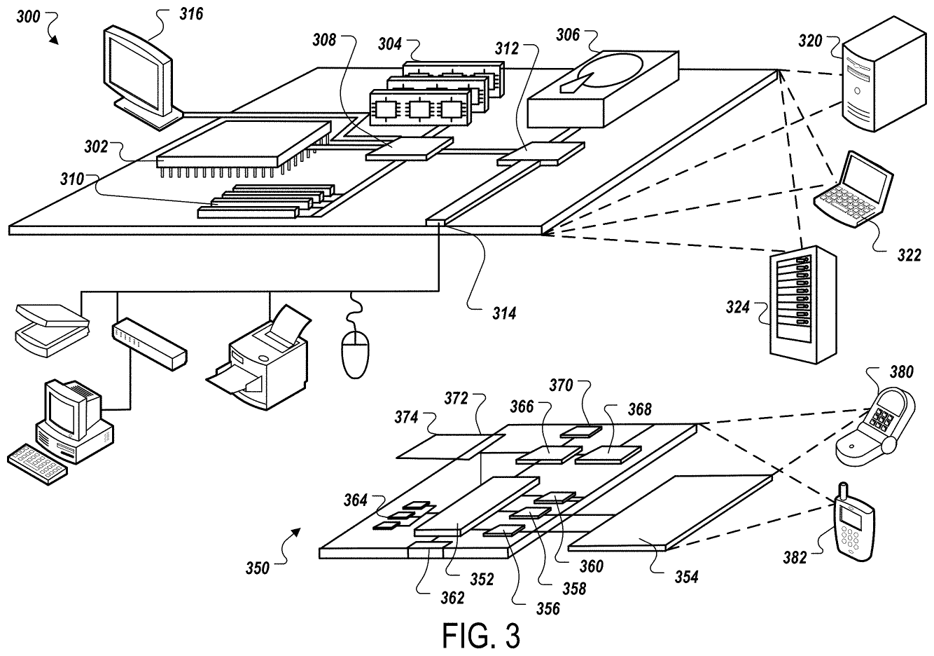

FIG. 3 is a diagram illustrating an example of a computing system used for distribution-based machine learning. The computing system includes computing device 300 and a mobile computing device 350 that can be used to implement the techniques described herein. For example, one or more components of the system 100 could be an example of the computing device 300 or the mobile computing device 350, such as a computer system implementing the control unit 120, devices that access information from the control unit 120, or a server that accesses or stores information regarding the operations performed by the control unit 120.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 302 is a single threaded processor. In some implementations, the processor 302 is a multi-threaded processor. In some implementations, the processor 302 is a quantum computer.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine readable mediums (for example, the memory 304, the storage device 306, or memory on the processor 302). The high-speed interface 308 manages bandwidth-intensive operations for the computing device 300, while the low-speed interface 312 manages lower bandwidth-intensive operations. Such allocation of functions is an example only. In some implementations, the high speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may include one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry in some cases. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 368 using a radio frequency. In addition, short-range communication may occur, such as using a Bluetooth, Wi-Fi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, among others) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

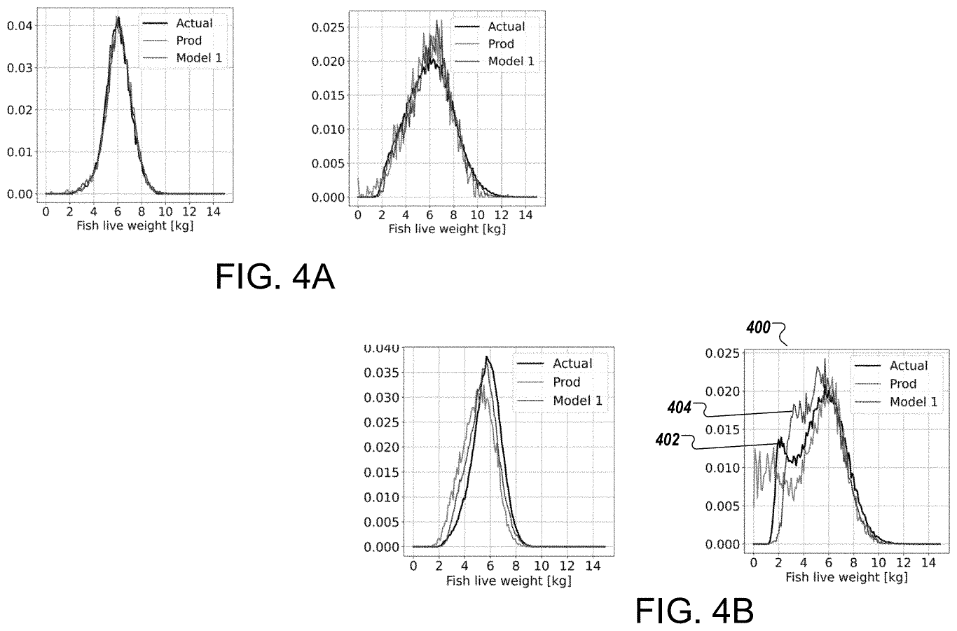

FIG. 4A is a diagram showing comparison results from evaluation tests of a model trained using distribution-based machine learning. FIG. 4B is a diagram showing comparison results from evaluation tests of a model trained using distribution-based machine learning. FIG. 4A and FIG. 4B show how model behavior can be dependent on obtaining a range of fish types for training. FIG. 4A shows well behaved actual distributions—e.g., where the actual distribution of fish weights was relatively Gaussian. In this regime, a model generally performs well in that it can predict the distribution with high accuracy—shown graphically as a difference between the lines Actual and Model 1. FIG. 4B shows less well behaved distributions—e.g., where the actual distribution of fish weights is non-Gaussian, such as the region 402 on the Actual line. The difference between line Model 1 and line Actual in plot 400 show that the model corresponding to model 1 may not have had sufficient training data for fish below, approximately, 5 kg.

As described in this document, the system 100 of FIG. 1 can help improve performance by augmenting distribution training data to include data representing fish not included in an original distribution. For the example of plot 400, the control unit 120 of the system 100 can obtain additional fish data (e.g., measured manually or by a connected component configured to measure fish or otherwise detect features of fish) and combine the additional fish data (e.g., localized in the low fish weight range) with existing fish data (e.g., localized in the middle to upper fish weight range). As a result, the control unit 120 can improve a trained model, such as the model 128. In some implementations, this improvement reduces a discrepancy, as shown in plot 400, between the Actual line 402 and Model 1 line 404.

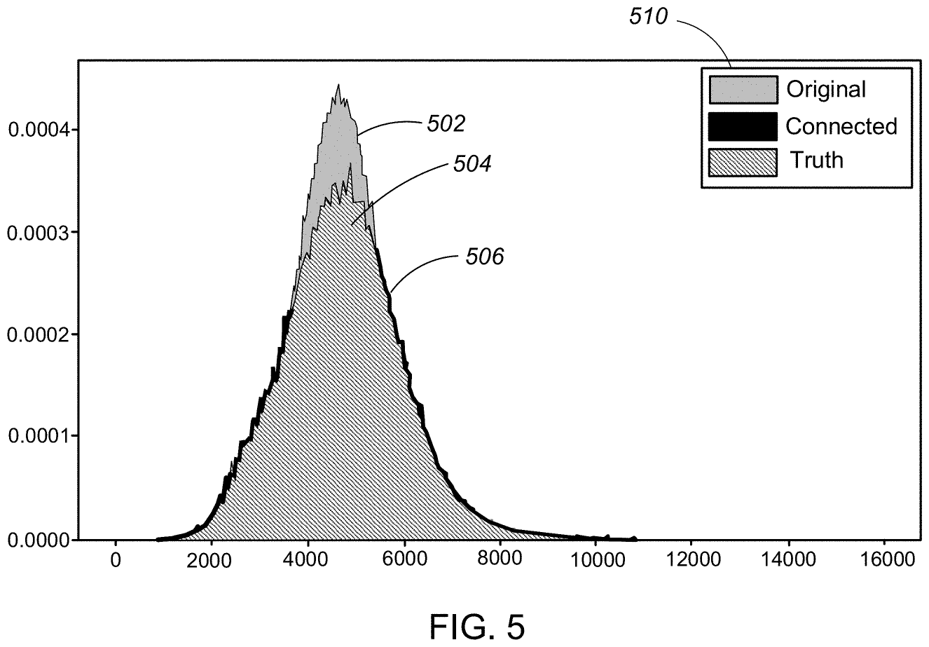

FIG. 5 is a diagram showing a comparison between an original distribution 502, a corrected distribution 504, and a ground truth distribution 506. As described in this document, the corrected distribution 504 can be output from one or more transforming functions, e.g., generated by one or more machine learning models, operating on the original distribution 502. The transforming functions can be tuned or adjusted during one or more iterations of training to better approximate a ground truth distribution 506. The ground truth distribution 506 can represent the weights of fish in an actual population before, after, or during harvesting. After training, the transforming functions used to transform the original distribution 502 to the corrected distribution 504 can be used for newly predicted distributions to correct them so that they better approximate a population, e.g., a population that has not yet been harvested and does not have ground truth data available.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
obtaining fish images from a camera device;
generating predicted values using a machine learning model and one or more of the fish images;
comparing the predicted values to distribution data representing features of multiple fish; and
updating one or more parameters of the machine learning model based on the comparison.

2. The method of claim 1, wherein the camera device is equipped with locomotion devices for moving within a fish pen.

3. The method of claim 1, wherein the predicted values include one or more values indicating a weight of a fish represented by the fish images.

4. The method of claim 1, wherein the fish images include two images from a pair of stereo cameras of the camera device.

5. The method of claim 1, comprising:
obtaining the distribution data representing the features of the multiple fish from a system that measures the multiple fish.

6. The method of claim 1, comprising:
measuring the multiple fish to generate the distribution data representing the features of the multiple fish.

7. The method of claim 6, wherein the features of the multiple fish include a total weight of the multiple fish.

8. The method of claim 1, comprising:
generating the distribution data representing the features of the multiple fish.

9. The method of claim 8, wherein generating the distribution data representing the features of the multiple fish comprises:
obtaining data representing fish satisfying a feature criteria; and
generating the distribution data as a combination of the data representing fish satisfying the feature criteria and data representing fish not satisfying the feature criteria.

10. The method of claim 9, wherein the feature criteria includes a weight threshold.

11. The method of claim 1, wherein comparing the predicted values to the distribution data representing the features of the multiple fish comprises:
comparing one or more values representing one or more predicted weights of fish represented in the fish images to one or more values representing one or more known weights of fish not represented in the fish images.

12. The method of claim 1, wherein generating the predicted values comprises:
generating a predicted distribution; and
generating a transformed version of the predicted distribution as the predicted values.

13. A non-transitory computer-readable medium storing one or more instructions executable by a computer system to perform operations comprising:
obtaining fish images from a camera device;
generating predicted values using a machine learning model and one or more of the fish images;
comparing the predicted values to distribution data representing features of multiple fish; and
updating one or more parameters of the machine learning model based on the comparison.

14. The medium of claim 13, wherein the camera device is equipped with locomotion devices for moving within a fish pen.

15. The medium of claim 13, wherein the predicted values include one or more values indicating a weight of a fish represented by the fish images.

16. The medium of claim 13, wherein the fish images include two images from a pair of stereo cameras of the camera device.

17. The medium of claim 13, wherein the operations comprise:
obtaining the distribution data representing the features of the multiple fish from a system that measures the multiple fish.

18. The medium of claim 13, wherein the operations comprise:
measuring the multiple fish to generate the distribution data representing the features of the multiple fish.

19. The medium of claim 18, wherein the features of the multiple fish include a total weight of the multiple fish.

20. A system, comprising:
one or more processors; and
machine-readable media interoperably coupled with the one or more processors and storing one or more instructions that, when executed by the one or more processors, perform comprising:
obtaining fish images from a camera device;
generating predicted values using a machine learning model and one or more of the fish images;
comparing the predicted values to distribution data representing features of multiple fish; and
updating one or more parameters of the machine learning model based on the comparison.
